(19) United States
(12) Patent Application Publication
(10) Pub. No.: US 2026/0025168 A1
(43) Pub. Date: Jan. 22, 2026

(54) SIMULTANEOUS REFLECTION AND SENSING MODE FOR RECONFIGURABLE INTELLIGENT SURFACES

(71) Applicant: QUALCOMM Incorporated, San Diego, CA (US)

(72) Inventors: Min HUANG, Beijing (CN); Jing DAI, Beijing (CN); Mingxi YIN, Beijing (CN); Wei XI, Beijing (CN); Chao WEI, Beijing (CN); Hao XU, Beijing (CN)

(21) Appl. No.: 18/995,057

(22) PCT Filed: Sep. 7, 2022
(86) PCT No.: PCT/CN2022/117460

§ 371 Date: Jan. 15, 2025

(51) Int. Cl. H04B 7/04; H04W 24/10

(52) U.S. Cl. CPC H04B 7/04013; H04W 24/10

(57) ABSTRACT

A reconfigurable intelligent surface (RIS) may transmit a capability report associated with the RIS. The capability report may be associated with reflection and sensing capabilities of the RIS. A network node may obtain the capability report associated with the RIS. The network node may transmit a first configuration of resources associated with at least one RS and a second configuration of at least one mode associated with the reflection and sensing capabilities of the RIS. The at least one mode may be associated with the at least one RS. The at least one mode may include a hybrid sensing and reflection mode. The RIS may receive the first configuration of resources associated with the at least one RS and the second configuration of the at least one mode associated with the reflection and sensing capabilities of the RIS.

### TECHNICAL FIELD

The present disclosure relates generally to communication systems, and more particularly, to a reconfigurable intelligent surface (RIS) system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may have a memory and at least one processor coupled to the memory at a network node. Based at least in part on information stored in the memory, the at least one processor may be configured to obtain a capability report associated with a reconfigurable intelligent surface (RIS). The capability report may be associated with reflection and sensing capabilities of the RIS. Based at least in part on information stored in the memory, the at least one processor may be configured to transmit a first configuration of resources associated with at least one reference signal (RS) and a second configuration of at least one mode associated with the reflection and sensing capabilities of the RIS. The at least one mode may be associated with the at least one RS. The at least one mode may include a hybrid sensing and reflection mode.

In an aspect of the disclosure, a method, a computer-readable medium, and an apparatus are provided. The apparatus may have a memory and at least one processor coupled to the memory at a RIS. Based at least in part on information stored in the memory, the at least one processor may be configured to transmit a capability report associated with the RIS. The capability report may be associated with reflection and sensing capabilities of the RIS. Based at least in part on information stored in the memory, the at least one processor may be configured to receive a first configuration of resources associated with at least one RS and a second configuration of at least one mode associated with the reflection and sensing capabilities of the RIS. The at least one mode may be associated with the at least one RS. The at least one mode may include a hybrid sensing and reflection mode.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a RIS configured to reflect, sense, or reflect and sense one or more reference signals (RSs) from a network node, in accordance with various aspects of the present disclosure.

FIG. 5 is a diagram illustrating an example of a system model of a RIS, in accordance with various aspects of the present disclosure.

FIG. 6 is a connection flow diagram illustrating an example of a RIS configured to reflect, sense, or reflect and sense one or more reference signals (RSs) configured by a network node, in accordance with various aspects of the present disclosure.

FIG. 7 is another connection flow diagram illustrating an example of a RIS configured to reflect, sense, or reflect and sense one or more reference signals (RSs) from a network node, in accordance with various aspects of the present disclosure.

FIG. 8A is a diagram illustrating an example of a configuration for a plurality of RIS modes, in accordance with various aspects of the present disclosure.

FIG. 8B is a diagram illustrating an example of a configuration for a plurality of RIS modes, in accordance with various aspects of the present disclosure.

FIG. 9 is a flowchart of a method of wireless communication.

FIG. 10 is another flowchart of a method of wireless communication.

FIG. 11 is another flowchart of a method of wireless communication.

FIG. 12 is another flowchart of a method of wireless communication.

FIG. 13 is another flowchart of a method of wireless communication.

FIG. 14 is a diagram illustrating an example of a hardware implementation for an example network entity.

FIG. 15 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network clement, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

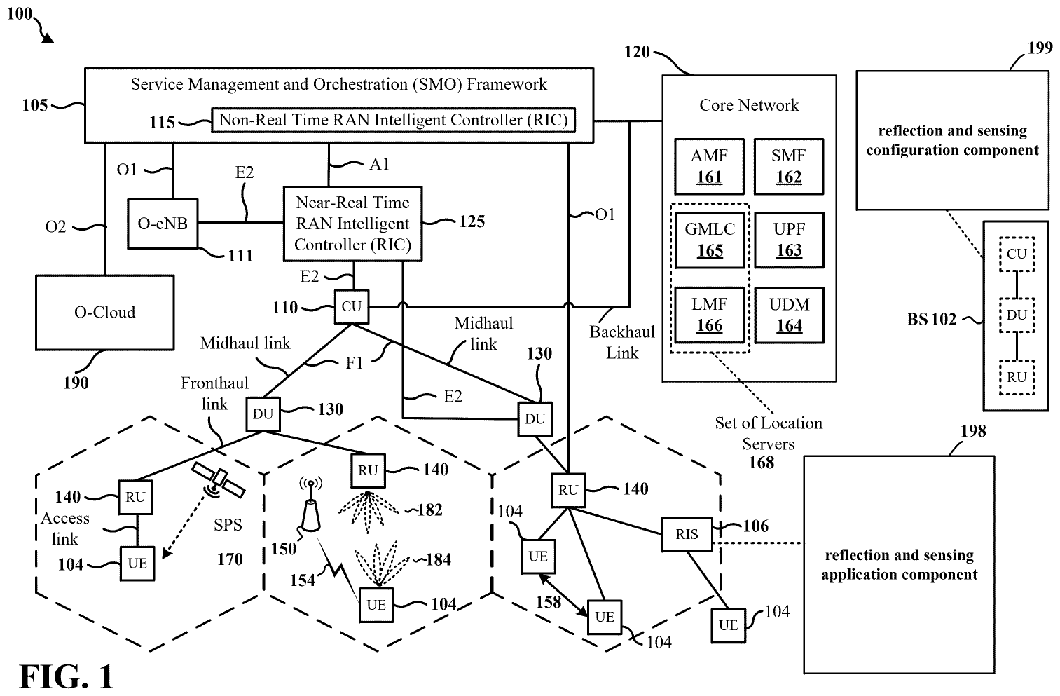

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

A RIS 106 may be a meta-surface configured to receive an incident wave from a base station 102 or an RU 140 of a base station 102. The RIS 106 may be configured to reflect the incident wave to a desired direction, sense one or more attributes of the incident wave, or reflect a portion of the incident wave and sense one or more attributes of a portion of the incident wave. The one or more attributes may include, for example, an angle of arrival (AoA), a phase, or an amplitude of the incident wave or portion of the incident wave.

Referring again to FIG. 1, in certain aspects, the RIS 106 may have a reflection and sensing application component 198 configured to transmit a capability report associated with the RIS. The capability report may be associated with reflection and sensing capabilities of the RIS. The reflection and sensing application component 198 may be configured to receive a first configuration of resources associated with at least one RS and a second configuration of at least one mode associated with the reflection and sensing capabilities of the RIS. The at least one mode may be associated with the at least one RS. The at least one mode may include a hybrid sensing and reflection mode. In certain aspects, the base station 102 may have a reflection and sensing configuration component 199 configured to obtain a capability report associated with a RIS. The capability report may be associated with reflection and sensing capabilities of the RIS. The reflection and sensing configuration component 199 may be configured to transmit a first configuration of resources associated with at least one RS and a second configuration of at least one mode associated with the reflection and sensing capabilities of the RIS. The at least one mode may be associated with the at least one RS. The at least one mode may include a hybrid sensing and reflection mode. Although the following description may be focused on RIS devices, the concepts described herein may be applicable to any device capable of sensing a portion of an incident wave and reflecting a portion of an incident wave. Although the following description may be focused on 5G NR, the concepts described herein may be applicable to other similar areas, such as LTE, LTE-A, CDMA, GSM, and other wireless technologies capable of transmitting wireless signals that may be reflected and/or sensed by a RIS device or a RIS-like device.

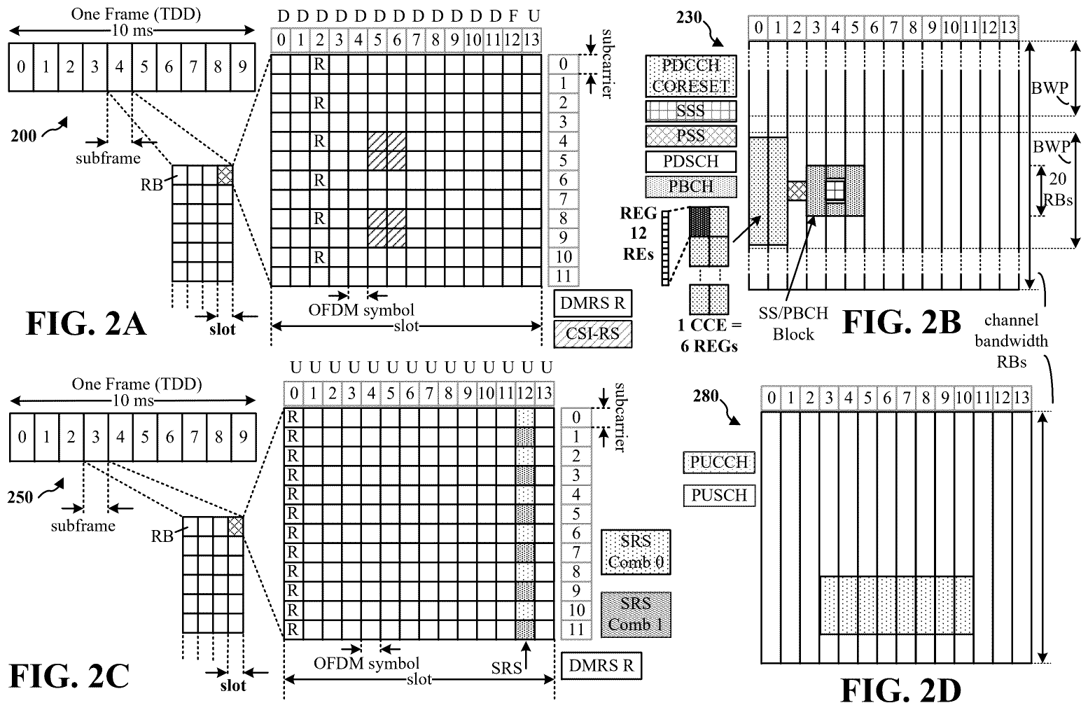

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{ρ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

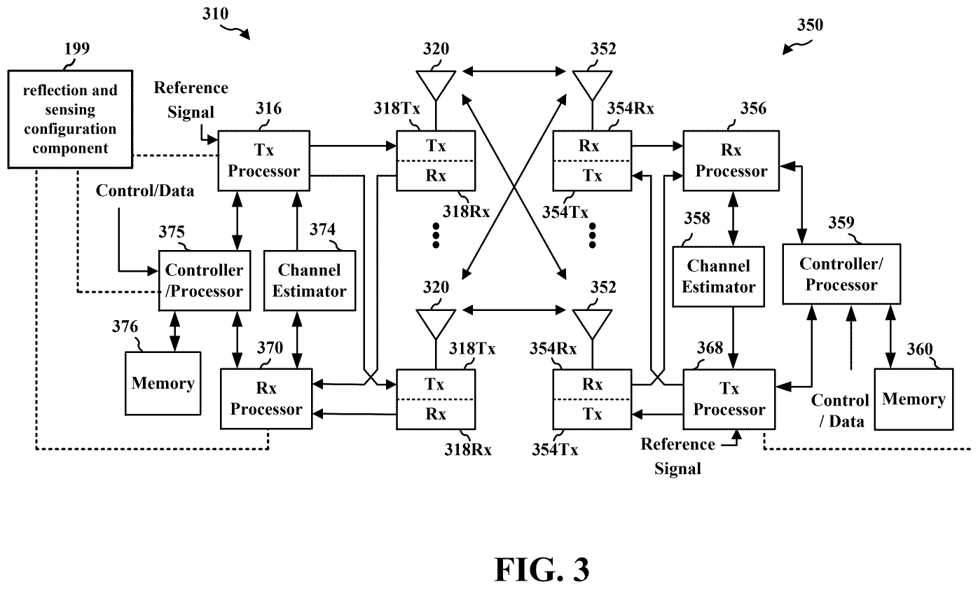

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 316, the Rx processor 370, and the controller/processor 375 may be configured to perform aspects in connection with the reflection and sensing configuration component 199 of FIG. 1.

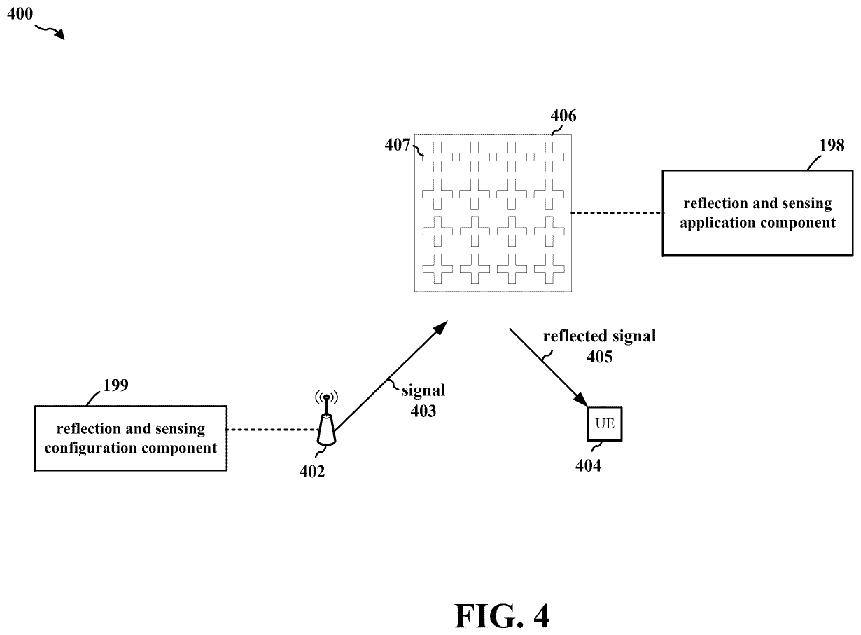

FIG. 4 is a diagram 400 illustrating an example of a RIS 406 configured to receive a signal 403 from a network node 402, and reflect a reflected signal 405 towards a UE 404. One or more of the meta-elements 407 of a meta-surface of the RIS 406 may have a sensing mode, a reflection mode, or a hybrid sensing and reflection mode.

When a meta-element 407 is switched to a reflection mode, the meta-element 407 may be configured to reflect the signal 403 to a desired direction. The configuration of one or more reflective elements, such as a meta-element 407, may be used to aim a signal 403 in a desired direction. For example, one or more reflection coefficients of the meta-element 407 may be changed to alter a direction that the reflected signal 405 is centered upon. For example, a first coefficient may be altered to change an amplitude of the reflected signal 405 from the meta-element 407 and a second coefficient may be altered to shift a phase of the reflected signal 405 from the meta-element 407. The configuration of the meta-element 407 of the RIS 406 may depend on the knowledge of the direction of the incident wave of the signal 403. In other words, the accuracy of where a meta-element 407 centers or aims the reflected signal 405 may be increased using information about the direction that the signal 403 approaches the meta-element 407 from, or an AoA of the signal 403 relative to the meta-element 407. However, if the meta-element 407 is configured to have a reflection mode and not a sensing mode, it may be difficult for a component of the RIS 406 to estimate the incident wave direction, and thus one or more reflection coefficients of the meta-element 407.

When a meta-element 407 is switched to a sensing mode, the meta-element 407 may be configured to sense one or more attributes of the signal 403. A meta-element may sense the signal 403 with a waveguide that is coupled to each meta-atom of the meta-element 407. Each waveguide may be connected to an RF chain, allowing the RIS 406 to locally process a portion of the received signal in a digital domain. By evaluating one or more phases of waveguide signals associated with one or more meta-elements (e.g., a meta-clement group), the RIS 406 may calculate an AoA of an arrived signal. In one aspect, when a plurality of waveguides are arrayed linearly, the AoA θ may satisfy

$$φ = \frac{2 π d sin θ}{λ} ,$$

where φ may be an inter-waveguide phase difference, d may be an inter-waveguide distance, and λ may be a wavelength of the received signal. Based on the calculated AoA, the RIS 406 may determine one or more reflection coefficients of each meta-clement 407 for a DL transmission (e.g., a signal from the network node 402 reflected off the RIS 406 to the UE 404) or an UL transmission (e.g., a signal from the UE 404 reflected off the RIS 406 to the network node 402.

When one or more meta-elements 407 of the RIS 406 is switched to a reflecting mode, it may be difficult for the RIS 406 to determine the proper reflection coefficients of each meta-element 407 to focus the direction of the reflected signal 405 to be centered on an antenna of the UE 404. When one or more meta-elements 407 of the RIS 406 is switched to a sensing mode, the RIS 406 may be able to determine one or more reflection coefficients for the signal 403 to focus the direction of the reflected signal 405, but the meta-element 407 in sensing mode is unable to reflect the signal 403. One or more meta-elements 407 of the RIS 406 may be configured to have both reflection and sensing capabilities such that the meta-surface of the RIS 406 may reflect one portion of an impinging signal in a controllable manner, while simultaneously sensing with the other portion of the impinging signal. In other words, one or more meta-elements 407 may have a hybrid sensing and reflection mode. In some aspects, one or more meta-elements 407 may be switched to a sensing mode while one or more other meta-elements may be switched to a reflection mode. Such a sensing capability may enable the RIS 406 to perform both channel estimation and localization. Based on a result of processing a received signal, such as the signal 403, using the sensing mode, the RIS 406 may determine one or more reflection coefficients for each meta-element 407 to optimize a direction of the reflected signal 405 so that the reflected signal 405 is centered on the UE 404, or an antenna of the UE 404.

The network node 402 may have a reflection and sensing configuration component 199. The reflection and sensing configuration component 199 may be configured to obtain a capability report associated with a RIS. The capability report may be associated with reflection and sensing capabilities of the RIS. The reflection and sensing configuration component 199 may be configured to transmit a first configuration of resources associated with at least one RS and a second configuration of at least one mode associated with the reflection and sensing capabilities of the RIS. The at least one mode may be associated with the at least one RS. The at least one mode may include a hybrid sensing and reflection mode.

The RIS 406 may have a reflection and sensing application component 198. The reflection and sensing application component 198 may be configured to transmit a capability report associated with the RIS. The capability report may be associated with reflection and sensing capabilities of the RIS. The reflection and sensing application component 198 may be configured to receive a first configuration of resources associated with at least one RS and a second configuration of at least one mode associated with the reflection and sensing capabilities of the RIS. The at least one mode may be associated with the at least one RS. The at least one mode may include a hybrid sensing and reflection mode.

As discussed supra, the reflection and sensing application component 198 is configured to transmit a capability report associated with the RIS. The capability report may be associated with reflection and sensing capabilities of the RIS. The reflection and sensing application component 198 may be configured to receive a first configuration of resources associated with at least one RS and a second configuration of at least one mode associated with the reflection and sensing capabilities of the RIS. The at least one mode may be associated with the at least one RS. The at least one mode may include a hybrid sensing and reflection mode. The reflection and sensing application component 198 may be within a processor of the RIS 406. The reflection and sensing application component 198 may be one or more hardware components specifically configured to carry out the stated processes/algorithm, implemented by one or more processors configured to perform the stated processes/algorithm, stored within a computer-readable medium for implementation by one or more processors, or some combination thereof. In one configuration, the RIS 406 includes means for transmitting a capability report associated with the RIS. The RIS 406 may include means for receiving a first configuration of resources associated with at least one RS and a second configuration of at least one mode associated with the reflection and sensing capabilities of the RIS. The RIS 406 may include means for activating the at least one mode based on the second configuration of the at least one mode. The RIS 406 may include means for activating the at least one mode based on the second configuration of the at least one mode by activating at least one of a sensing mode or a reflection mode. The RIS 406 may include means for activating the at least one mode based on the second configuration of the at least one mode by activating a sensing mode associated with a first time period. The RIS 406 may include means for activating the at least one mode based on the second configuration of the at least one mode by activating the hybrid sensing and reflection mode associated with a second time period. The RIS 406 may include means for activating the at least one mode based on the second configuration of the at least one mode by activating a reflection mode during a third time period in between the first time period and the second time period. The RIS 406 may include means for activating the at least one mode based on the second configuration of the at least one mode by activating a second sensing mode associated with a fourth time period. The RIS 406 may include means for activating the at least one mode based on the second configuration of the at least one mode by activating a second hybrid sensing and reflection mode associated with a fifth time period. The RIS 406 may include means for activating the at least one mode based on the second configuration of the at least one mode by activating the sensing mode during the overlap time period in response to the first time period overlapping with the second time period during the overlap time period. The RIS 406 may include means for activating the at least one mode based on the second configuration of the at least one mode by activating the at least one mode periodically. The RIS 406 may include means for applying a first sensing power and reflection power ratio to the hybrid sensing and reflection mode in response to the SNR performance of the at least one RS being greater than or equal to the SNR threshold. The RIS 406 may include means for applying a second sensing power and reflection power ratio to the hybrid sensing and reflection mode in response to the SNR performance of the at least one RS being less than or equal to the SNR threshold. The RIS 406 may include means for estimating an AoA of the at least one RS based on the first configuration of the resources during at least one of a sensing mode or the hybrid sensing and reflection mode of the at least one mode. The RIS 406 may include means for adjusting a meta-element reflection coefficient based on the estimate of the AoA. The RIS 406 may include means for reflecting the at least one RS during at least one of the hybrid sensing and reflection mode or a reflection mode of the at least one mode. The means may be the reflection and sensing application component 198 of the RIS 406 configured to perform the functions recited by the means.

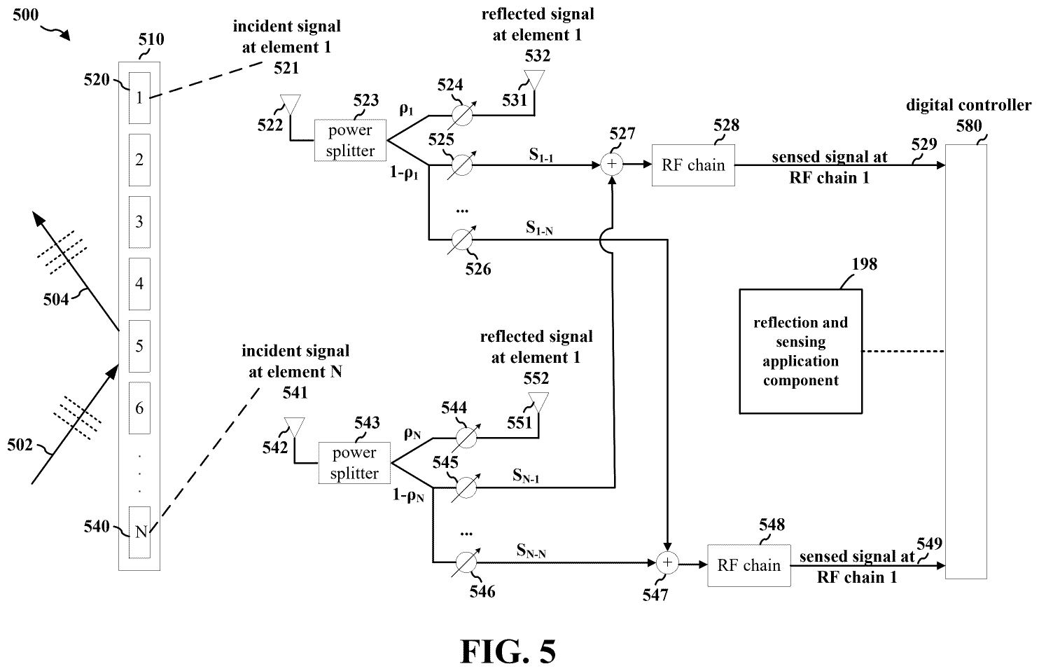

FIG. 5 is a diagram 500 illustrating an example of a system model of a RIS having a meta-surface 510 configured to sense the incident signal 502 and reflect the incident signal 502 to create the reflected signal 504. The meta-surface 510 may have a plurality of meta-elements numbered from meta-element 1 520 to meta-clement N 540. The meta-surface 510 may be configured to operate in at least one mode associated with reflection and sensing capabilities of the RIS, such as a reflection mode, a sensing mode, or a hybrid sensing and reflection mode.

A portion of the incident signal 502 may be received by the meta-element 1 520, which receives the incident signal at element 1 521 via the receiving antenna 522. If the meta-clement 1 520 operates in the hybrid sensing and reflection mode, the hybrid-RIS may divide the arrived signal power such that part of the power is reflected and part of the power is received. A power splitter 523 may split the received incident signal at element 1 521 such that pi of the power is directed towards the meter 524 for reflection, and 1−ρ₁ of the power is directed towards the meters 525 to 526 for sensing, where ρ₁≤1. If ρ₁=0, the meta-element 1 520 may be configured to operate in a sensing mode. If ρ₁=1, the meta-element 1 520 may be configured to operate in a reflection mode. If 0<ρ₁<1, the meta-element 1 520 may be configured to operate in a hybrid sensing and reflection mode.

The portion of the incident signal at element 1 521 directed towards the meter 524 may be reflected via the antenna 531 as the reflected signal at element 1 532. One or more reflection coefficients of the antenna 531 may be used to focus the reflected signal at element 1 532 towards a target device, such as the network node 402 in FIG. 4 or the UE 404 in FIG. 4.

The portion of the incident signal at element 1 521 directed towards the meter 525 may be accumulated by the accumulator 527 to be fed to an RF chain 528. The accumulator 527 may also receive a portion of the incident signal at element N 541 directed towards the meter 545. The received signals accumulated by the accumulator 527 may be used to enhance the sensed signal power by connecting multiple meta-elements to a common waveguide at the RF chain 528 to generate the sensed signal at RF chain 1 529. The RF chain may have an analog-to-digital converter to convert the sensed signal at the RF chain 1 529 to a digital signal. A plurality of channel outputs may be propagated to a plurality of ports in a microstrip to be fed to a digital controller 580, which may sense one or more attributes of the accumulated signal, such as an inter-waveguide phase difference or a wavelength to the received signal. The digital controller 580 may provide feedback to the power splitter 523 to control the power splitting. The digital controller 580 may provide feedback to the one or more of the meters 524, 525, and 526 to control phase shifts of the received signals.

A portion of the incident signal 502 may be received by the meta-element N 540, which receives the incident signal at element N 541 via the receiving antenna 542. If the meta-clement N 540 operates in the hybrid sensing and reflection mode, the hybrid-RIS may divide the arrived signal power such that part of the power is reflected and part of the power is received. A power splitter 543 may split the received incident signal at element N 541 such that ρ_{N} of the power is directed towards the meter 544 for reflection, and 1−ρ_{N} of the power is directed towards the meters 545 to 546 for sensing, where ρ_{N}≤1. If ρ_{N}=0, the meta-element N 540 may be configured to operate in a sensing mode. If ρ_{N}=1, the meta-element N 540 may be configured to operate in a reflection mode. If 0<ρ_{N}<1, the meta-element N 540 may be configured to operate in a hybrid sensing and reflection mode.

The portion of the incident signal at element N 541 directed towards the meter 544 may be reflected via the antenna 551 as the reflected signal at element N 552. One or more reflection coefficients of the antenna 551 may be used to focus the reflected signal at element N 552 towards a target device, such as the network node 402 in FIG. 4 or the UE 404 in FIG. 4.

The portion of the incident signal at element N 541 directed towards the meter 545 may be accumulated by the accumulator 547 to be fed to an RF chain 548. The accumulator 547 may also receive a portion of the incident signal at element 1 521 directed towards the meter 525. The received signals accumulated by the accumulator 547 may be used to enhance the sensed signal power by connecting multiple meta-elements to a common waveguide at the RF chain 548 to generate the sensed signal at RF chain 1 549. The RF chain may have an analog-to-digital converter to convert the sensed signal at the RF chain 1 549 to a digital signal. A plurality of channel outputs may be propagated to a plurality of ports in a microstrip to be fed to a digital controller 580, which may sense one or more attributes of the accumulated signal, such as an inter-waveguide phase difference or a wavelength to the received signal. The digital controller 580 may provide feedback to the power splitter 543 to control the power splitting. The digital controller 580 may provide feedback to the one or more of the meters 544, 545, and 546 to control phase shifts of the received signals. The digital controller 580 may be configured to perform aspects in connection with the reflection and sensing application component 198 of FIG. 1, for example by activating an RIS mode.

Each of the meta-elements 1 520 to N 540 may be configured to operate in one of three modes individually and independently, or the meta-surface 510 of meta-elements 1 to N 540 may be configured to operate as a meta-element group in one of three modes together.

A sensing mode may use all of the received power to sense (e.g., ρ_{1-N}=0). Using the sensing mode, the meta-surface 510 may be used to estimate the AoA of the received incident signal 502. The sensing mode may be used to initially detect a direction of a transmitting device, such as the network node 402 or UE 404 in FIG. 4. Based on the direction of the AoA, the reflection and sensing application component 198 may determine the proper reflection coefficients (e.g., the phase value) of each of the meta-elements 1 520 to N 540 of the meta-surface 510. Thus, the reflection and sensing application component 198 may maximize the power received by a network node in UL or by a UE in DL. The sensing mode may be used when the received signal strength from a transmitting device, such as a new UE, is unknown, allowing for all of the received power of the incident signal at element 1 521 to be used in sensing.

A reflection mode may use all of the received power to reflect (e.g., ρ_{1-N}=1). Using the reflection mode, the meta-surface 510 may be used for data transmission between two wireless devices, such as a network node and a UE, after sensing is performed by the RIS.

A hybrid sensing and reflection mode may divide partial received power to sensing and partial received power to reflection, respectively. The hybrid sensing and reflection mode may be used to track a movement of a UE. The hybrid sensing and reflection mode may use some of the received power to sense and some of the received power to reflect (e.g., 0<ρ_{1-N}<1). The hybrid sensing and reflection mode may be used when the received signal strength from a transmitting device, such as a UE, is known. The RIS may be able to successfully sense attributes of the incident signal at element 1 521 in sensing with less power dedicated towards sensing, allowing the unused portion of power to be reflected to improve throughput and spectrum efficiency. Protocol and signaling messages may be used by the reflection and sensing application component 198 to determine which mode to switch to, power division in the hybrid sensing and reflection mode, and reflection coefficients of the meta-elements 1 520 to N 540.

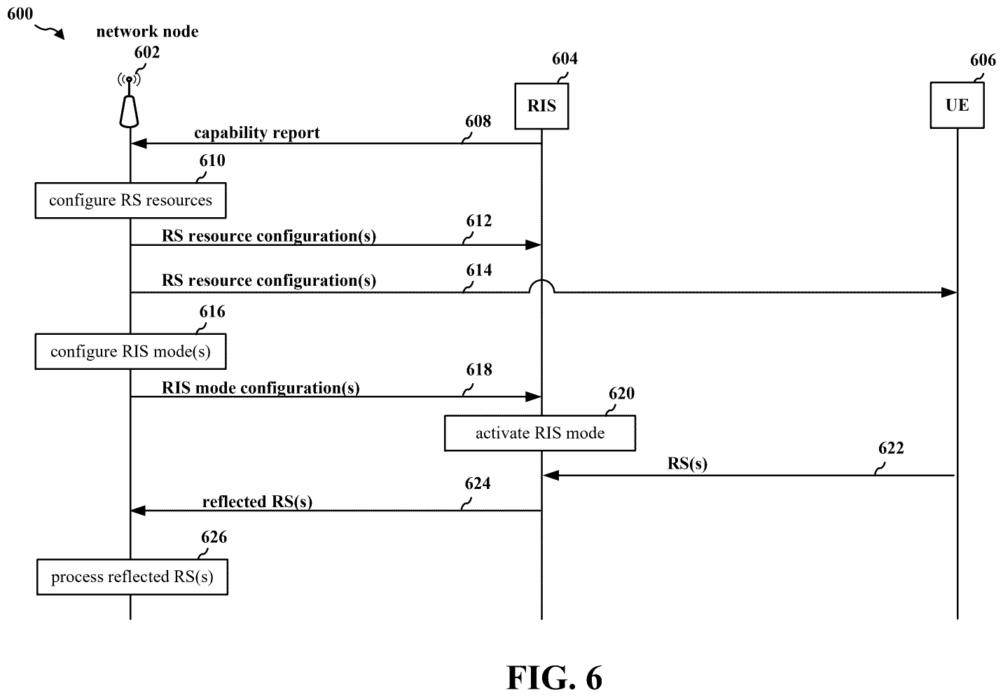

FIG. 6 is a connection flow diagram 600 illustrating an example of a RIS 604 configured to reflect, sense, or reflect and sense one or more reference signals (RSs) configured by a network node 602 for a UE 606.

The RIS 604 may transmit a capability report 608 to the network node 602. The network node 602 may receive the capability report 608 from the RIS 604. The capability report 608 may include an indication that the RIS 604 supports a sensing mode or an indication that the RIS 604 does not support a sensing mode. The capability report 608 may include an indication that the RIS 604 supports a hybrid sensing and refection mode or an indication that the RIS 604 does not support a hybrid sensing and reflection mode. The capability report 608 may include an indication of a time domain length to complete sensing if the RIS 604 is switched to a sensing mode or to a hybrid sensing and reflection mode. The capability report 608 may include an indication of a latency to complete sensing if the RIS 604 is switched to a sensing mode or to a hybrid sensing and reflection mode.

At 610, the network node 602 may configure one or more RS resources for the RIS 604 to reflect, or may configure one or more RS resources for the UE 606 to transmit. At 610 the network node 602 may also configure one or more RIS modes for the RIS 604 to switch to for one or more time periods. In one aspect, the network node 602 may configure an UL reference signal resource (e.g., an SRS) with an associated attribute that indicates to the RIS 604 that the RIS 604 should switch to a mode, such as a reflection mode, a sensing mode, or a hybrid sensing and reflection mode. In addition to configuring UL reference signal parameters for transmission (e.g., for transmission by the UE 606 to the network node 602), the network node 602 may also configure the UL reference signal parameters for reception (e.g., for reception by the RIS 604 from the UE 606). The time domain length for the UL reference signal for a sensing mode or a hybrid sensing and reflection mode may be based on the sensing capability of the RIS 604. In other words, the time domain length for the UL reference signal for a sensing mode or a hybrid sensing and reflection mode may be based on the capability report 608 received by the network node 602 from the RIS 604.

In one aspect, the network node 602 may configure a DL reference signal (e.g., a CSI-RS) with an associated attribute that indicates to the RIS 604 that the RIS 604 should switch to a mode, such as a reflection mode, a sensing mode, or a hybrid sensing and reflection mode. In addition to configuring the DL reference signal parameters for transmission (e.g., for transmission by the network node 602 to the UE 606), the network node 602 may also configure the DL reference signal parameters for reception (e.g., for reception by the RIS 604 from the network node 602). The time domain length for the DL reference signal for a sensing mode or a hybrid sensing and reflection mode may be based on the sensing capability of the RIS 604. In other words, the time domain length for the DL reference signal for a sensing mode or a hybrid sensing and reflection mode may be based on the capability report 608 received by the network node 602 from the RIS 604.

The one or more RS resource configurations 612 may include, for example, DCI or a medium access control (MAC) control element (MAC-CE) that schedules an UL or a DL reference signal. The one or more RS resource configurations 612 may include, for example, an indication to the RIS 604 to switch to a mode for a period of time, such as a sensing mode, a reflection mode, or a hybrid sending and reflection mode. The indication may be in a field or in a part of a field of DCI or a MAC-CE. The network node 602 may be configured to schedule an UL reference signal or a DL reference signal during a time period when the network node 602 schedules the RIS 604 to be set to a reflection mode. The network node 602 may be configured to schedule an UL reference signal and not to schedule a DL reference signal during a time period when the network node 602 schedules the RIS 604 to be set to a sensing mode or a hybrid sensing and reflection mode. The one or more RS resource configurations 612 may schedule a periodic pattern or an aperiodic trigger of a mode switch for the RIS 604. In other words, the one or more of the modes may be scheduled to repeat periodically, or may be scheduled for a particular period of time. The one or more RS resource configurations 612 may schedule resources for a plurality of UEs. The one or more RS resource configurations 612 may include a transmission grant to the UE 606. The one or more RS resource configurations 612 may include a resource identifier, for example an SRS resource identifier. Such an identifier may be useful in system having a plurality of UEs that transmit or receive data during an overlapping time period.

The one or more RS resource configurations 614 may be the same as the one or more RS resource configurations 612. In one aspect, the one or more RS resource configurations 612 and the one or more RS resource configurations 614 may include DCI or a MAC-CE that schedules a UL reference signal or a DL reference signal for the UE 606. The one or more RS resource configurations 614 may be different than the one or more RS resource configurations 612. In one aspect, the one or more RS resource configurations 614 may include DCI or a MAC-CE that schedules a UL reference signal or a DL reference signal for the UE 606 and the one or more RS resource configurations 612 may include a signal including one or more indicators of one or more attributes or parameters of the one or more RSs 622.

The network node 602 may transmit the one or more RS resource configurations 614 to the UE 606. The UE 606 may receive the one or more RS resource configurations 614 from the network node 602. The UE 606 may use the one or more RS resource configurations 614 to transmit an UL reference signal to the network node 602 via the RIS 604 or to receive a DL reference signal from the network node 602 via the RIS 604.

The network node 602 may transmit one or more RS resource configurations 612 to the RIS 604. The RIS 604 may receive one or more RS resource configurations 612 from the network node 602. The RIS 604 may use the one or more RS resource configurations 612 to configure one or more parameters for reflection of the one or more RSs 622 transmitted to the RIS 604 by the UE 606.

At 616, the network node 602 may configure one or more RIS modes for the RIS 604. The network node 602 may transmit the one or more RIS mode configurations 618 to the RIS 604. The RIS 604 may receive the one or more RIS mode configurations 618 from the network node 602. In one aspect, the one or more RIS mode configurations 618 may be the same as the one or more RS resource configurations 612. For example, the one or more RS resource configurations 612 and the one or more RIS mode configurations 618 may include DCI or a MAC-CE that schedules one or more UL reference signals or DL reference signals for the UE 606, which may also include an indicator for the RIS 604 to switch to a mode during a scheduled transmission. For example, a sensing mode for a first UL transmission and a hybrid sensing and reflection mode for a second UL transmission.

At 620, the RIS 604 may activate the RIS mode. If the mode is a sensing mode, the RIS 604 may perform sensing but may not perform reflection of the one or more RSs 622. If the mode is a reflection mode, the RIS 604 may perform reflection of the one or more RSs 622 from the UE 606 to generate one or more reflected RSs 624 to the network node 602. If the mode is a hybrid sensing and reflection mode, the RIS 604 may perform sensing on the one or more RSs 622 using part of the power of the one or more RSs 622, and may reflect the one or more RSs 622 to generate one or more reflected RSs 624 using part of the power of the one or more RSs 622. In some aspects, the RIS 604 may activate a mode periodically, for example a sensing mode or a reflection mode after a period of time for a number of cycles.

In one aspect, while the RIS 604 is in a hybrid sensing and reflection mode, the RIS 604 may change the divided power for sensing based on the incident signal's variation. For example, in response to a movement of the UE 606, a change of a strength of the arrived signal from the one or more RSs 622, or a change of a number and/or distribution of multiple arrival paths to the RIS 604, the RIS 604 may be configured to change a ratio between the power for sensing and the power for reflection. The sensing mode of the RIS 604 may include estimating a direction or AoA of the one or more RSs 622 from the UE 606. Such estimates may be performed by the RIS 604 based on Rx beam sweeping, multiple signal classification (MUSIC), compressive sensing, or machine learning algorithms. In one aspect, the RIS 604 may be configured to increase an SNR based on a number of UEs communicating with the RIS 604, a number of propagation paths, a distance from the RIS 604 that the UE 606 relocates, or a speed that the UE 606 moves.

In one aspect, the RIS 604 may be configured to re-determine the power division between reflection and sensing, and reflect and sense using the new power ratio. For example, the RIS 604 may be configured to update the power division based on sensing performance. If the sensing performance becomes worse (e.g., SNR of the sensed signal is lower or equal to a threshold value), the RIS 604 may divide more power in sensing (e.g., lower a ρ value). If the sensing performance becomes better (e.g., SNR of the sensed signal is higher or equal to a threshold value), the RIS 604 may divide less power in sensing (e.g., increase a ρ value). In one aspect, the network node 602 may be configured to detect the SNR from the RIS 604 and provide feedback to the RIS 604 at 616 in one or more RIS mode configurations 618. The network node 602 may be configured to determine an UL transmission format based on the recent received power of the one or more reflected RSs 624 (e.g., an SRS) while the RIS 604 is in a hybrid sensing and reflection mode. For example, the network node 602 may determine a PUSCH format, which may include a modulation and coding scheme (MCS), a number of layers of the format, or a precoding matrix of the format.

In one aspect, if the RIS 604 is operating in a reflection mode or a hybrid sending and reflection mode, the RIS 604 may reflect the one or more RSs 622 using the reflection coefficients determined while the RIS 604 was in sensing mode, or determined while the RIS 604 is in the hybrid sending and reflection mode.

The UE 606 may transmit one or more RSs 622 to the RIS 604 based on the one or more RS resource configurations 614. The UE 606 may transmit the one or more RSs 622 to the RIS 604 when the RIS 604 is in sensing mode or when the RIS 604 is in a hybrid sensing and reflection mode. When the RIS 604 is in sensing mode or hybrid sensing and reflection mode, the RIS 604 may measure one or more attributes of the one or more RSs 622, which may be used to calculate an AoA of an arrived signal. When the RIS 604 is in sensing mode, the RIS 604 may perform sensing with all of the received power of the one or more RSs 622 to estimate the AoA of the one or more RSs 622 and determine reflection coefficients for each meta-element of the RIS 604. When the RIS 604 is in a hybrid sensing and reflection mode, the RIS 604 may perform sensing with partial received power of the one or more RSs 622 to estimate the AoA of the one or more RSs 622 and determine reflection coefficients for each meta-element of the RIS 604. If the RIS 604 is in sensing mode or in hybrid sensing and reflection mode, while the UE 606 transmits or receives a reference signal, the RIS 604 may use the stored direction sensed by the RIS 604 to generate corresponding DL/UL reflection coefficients for one or more meta-elements of the RIS 604. If the RIS 604 is in hybrid sensing and reflection mode, the RIS 604 may determine a power division between reflection and sensing based on the received signal power and/or sensing conditions. The RIS 604 may reflect the one or more reflected RSs 624 with the determined reflection power.

In one aspect, if UE 606 transmits the one or more RSs 622, such as an SRS, to the RIS 604 and no other UE transmits any signals to the RIS 604, the RIS 604 may sense one direction or a set of paths associated with the one or more RSs 622. In response, the RIS 604 may determine one or more reflection coefficients based on a sensed direction or a major path. In another aspect, if there are a plurality of UEs transmitting signals that are received by the RIS 604, and one of the plurality of UEs is the UE 606 transmitting the one or more RSs 622 to the RIS 604, the RIS 604 may sense multiple directions or a path associated with a plurality of UEs. The RIS 604 may estimate and store the direction, or AoA, for each reference signal (e.g., each SRS resource), which may be equivalent to associating each direction, or AoA, with a discrete UE of the plurality of UEs. In other words, if the RIS 604 receives several SRS resources, The RIS 604 may link each SRS resource to one UE. While the UE 606 transmits the one or more RSs 622, the RIS 604 may use the stored UE direction, or AoA, to generate corresponding UL reflection coefficients of meta-elements. As corollary, if the RIS 604 were to receive a set of RSs from the network node, the RIS 604 may use the stored UE direction, or AoA, to generate corresponding DL reflection coefficients of meta-elements of the RIS 604.

In one aspect, if the RIS 604 is operating in a reflection mode, in a DL or UL slot or symbol, the RIS 604 may be configured to use a corresponding reflection coefficient for DL or UL, respectively. In another aspect, if the RIS 604 is operating in a hybrid sensing and reflection mode, the RIS 604 may use corresponding reflection coefficients for UL to reflect the one or more RSs 622. Since the RIS 604 performs sensing to determine proper reflection

When the RIS 604 is in reflection mode or hybrid sensing and reflection mode, the RIS 604 may use reflection coefficients based on one or more attributes of the one or more RSs 622. The RIS 604 may be able to perform sensing in its sensing mode to determine proper reflection coefficients of meta-elements of the RIS 604, so that the SNR of the one or more reflected RSs 624 may be improved. When the RIS 604 is in a hybrid sensing and reflection mode, the RIS 604 may use partial received power for its sensing operation, and the rest of the received power may be reflected to deliver the one or more reflected RSs 624 so that the spectrum efficiency may be improved. Such a hybrid mode also provides a short latency to track a movement of the UE 606.

At 626, the network node 602 may process the one or more reflected RSs 624, such as by measuring a reference signal received power (RSRP) of the one or more reflected RSs 624, or by measuring a phase shift of the one or more reflected RSs 624. The network node 602 may generate one or more updated RS resource configurations based on the processing of the one or more reflected RSs 624. For example, the network node 602 may update a transmission format of the RIS 604 based on the measured RSRP of the one or more reflected RSs 624.

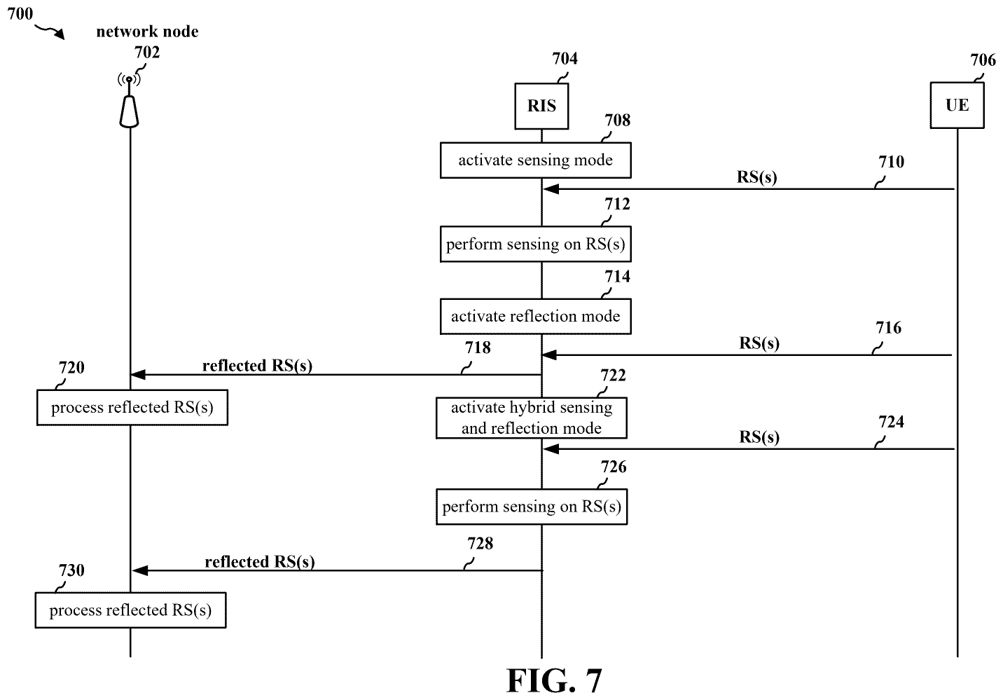

FIG. 7 is a connection flow diagram 700 illustrating an example of a RIS 704 configured to reflect, sense, or reflect and sense one or more reference signals (RSs) from the UE 706 to the network node 702. At 708, the RIS 704 may activate a sensing mode. The UE 706 may transmit one or more RSs 710 to the RIS 704. The RIS 704 may receive the one or more RSs 710 from the UE 706. At 712, the RIS 704 may perform sensing on the one or more RSs 710 to sense one or more attributes (e.g., wavelength, inter-waveguide phase difference) of the one or more RSs 710 transmitted from the UE 706 to the RIS 704. The RIS 704 may calculate one or more reflection coefficients based on the sensed attributes. At 714, the RIS 704 may activate a reflection mode. The UE 706 may transmit one or more RSs 716 to the RIS 704. The RIS 704 may receive the one or more RSs 716 from the UE 706. The RIS 704 may reflect the one or more RSs 716 using the calculated one or more reflection coefficients based on the sensed attributes at 712. The RIS 704 may receive the one or more RSs 716 and may reflect the one or more RSs 716 using full power and the one or more reflection coefficients calculated at 712 to generate the one or more reflected RSs transmitted to the network node 702. The network node 702 may receive the one or more reflected RSs 718 and may process the one or more reflected RSs 718 at 720.

At 722 the RIS 704 may activate a hybrid sensing and reflection mode. The RIS 704 may use the reflection coefficients calculated based on the attributes calculated at 712 during the sensing mode of the RIS 704. The UE 706 may transmit one or more RSs 724 to the RIS 704. The RIS 704 may receive the one or more RSs 724 from the UE 706. The RIS 704 may use part of the received power of the one or more RSs 724 to reflect the one or more reflected RSs 728. At 726, the RIS 704 may use part of the received power of the one or more RSs 724 to sense attributes of the one or more RSs 724, such as a new AoA or a speed that the UE 706 is traveling. The RIS 704 may continue to update one or more attributes of the one or more RSs 724 to update any reflection coefficients the RIS 704 may be using. The RIS 704 ay use the updated reflection coefficients to reflect the one or more RSs 724 to generate the one or more reflected RSs 728. The RIS 704 may transmit or reflect the one or more reflected RSs 728 to the network node 702. The network node 702 may receive the one or more reflected RSs 728. At 730, the network node 702 may process the one or more reflected RSs 728.

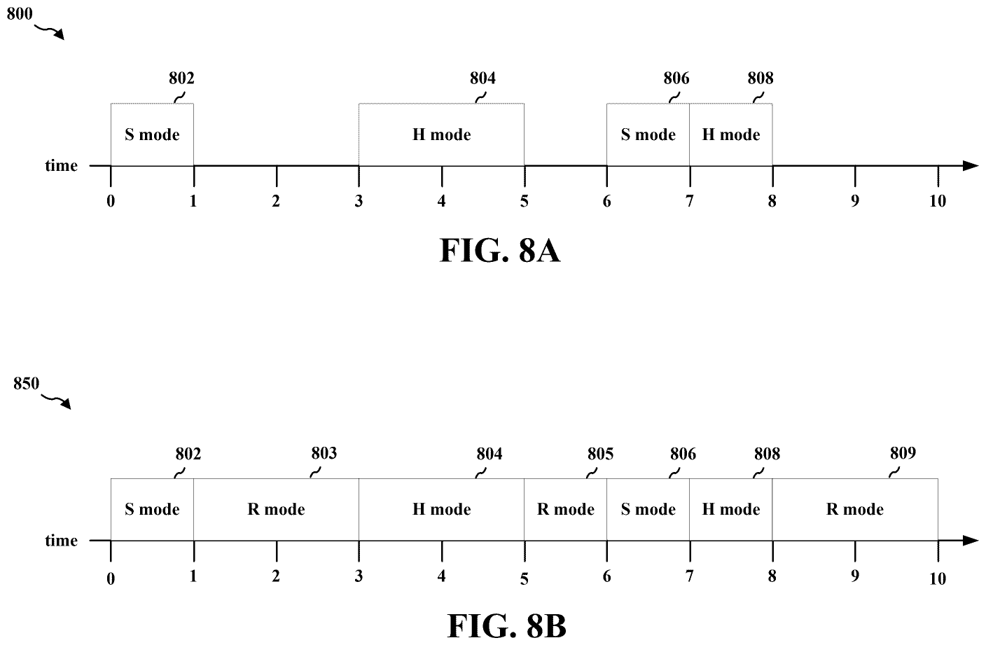

FIG. 8A is a diagram 800 illustrating an example of a configuration for a plurality of RIS modes. The diagram 800 may be representative of a configuration received by an RIS, such as the one or more RIS mode configurations 618 in FIG. 6. The configuration may include, for example, a sensing mode 802 that starts at time 0 may be periodic and repeat every six time slots as sensing mode 806 at time 6. The configuration may also include the hybrid sensing and reflection mode 804 at time slots 3 and 4, and the hybrid sensing and reflection mode 808 at time slot 7. The sensing mode 802 and 806 may be considered periodic RIS modes that repeat every six time slots. The hybrid sensing and reflection mode 804 and 808 may be considered dynamic or aperiodic RIS modes that do not repeat.

A periodic or semi-persistent mode pattern may be configured by a network node, such as the network node 602 in FIG. 6. A sensing mode, such as the sensing mode 802 and 806, may be associated with a longer period of time than a hybrid sensing and reflection mode. If a sensing mode and a hybrid mode have an overlapping time period, the RIS 604 may be configured to apply the sensing mode during the overlap. In diagram 800 in FIG. 8A, the configuration may not have a reflection mode. The RIS may be configured to apply a reflection mode in any interval between two sensing modes, two hybrid sensing and reflection modes, or between a sensing mode and a hybrid sensing and reflection mode.

FIG. 8B is a diagram 850 illustrating an example of an updated configuration of the diagram 500 for a plurality of RIS modes. The diagram 850 illustrates a sensing mode 802 at time 0, a reflection mode 803 applied at times 1 and 2 in between the sensing mode 802 and the hybrid sensing and reflection mode 804, and a hybrid sensing and reflection mode 804 at times 3 and 4. The diagram 850 also illustrates that the sensing mode 806 may be periodic and repeat at time 6, and in between the sensing mode 806 at time 5 and the hybrid sensing and reflection mode 804 at time 4, the RIS may apply a reflection mode 805. The RIS may also apply the reflection mode 809 after any scheduled sensing modes or hybrid sensing and reflection modes. If a network node detects that a receiving SNR becomes worse, the network node may configure dynamic or aperiodic sensing modes or hybrid sensing and reflection modes to readjust the reflection coefficient of the RIS.

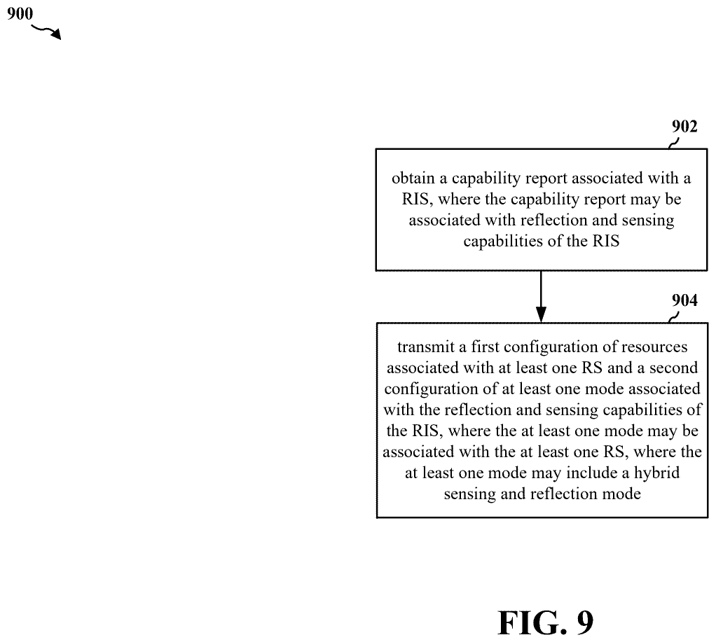

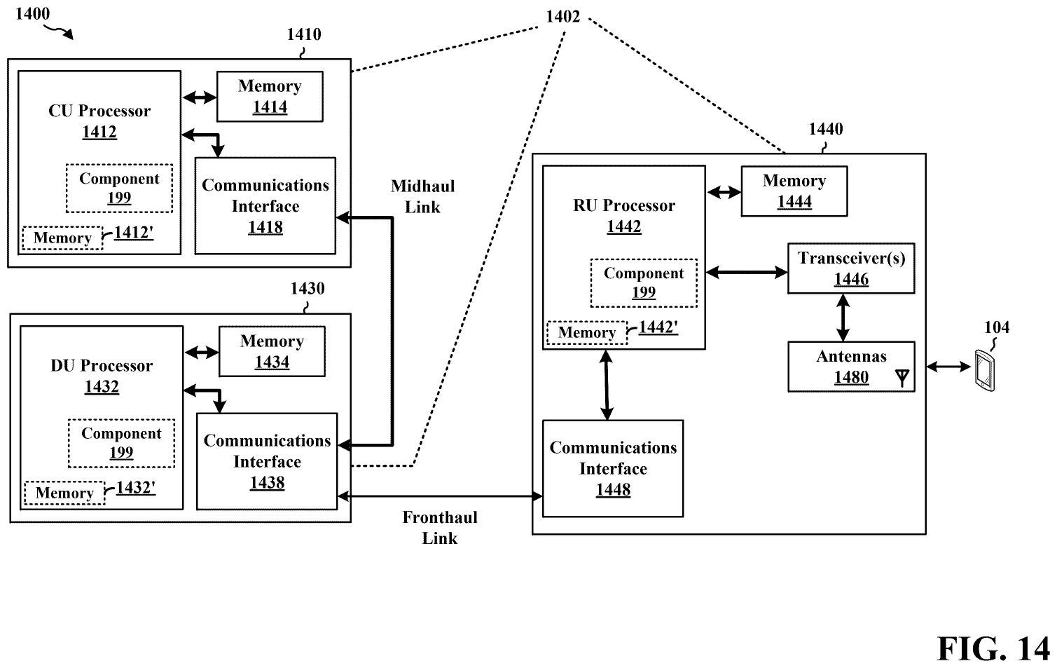

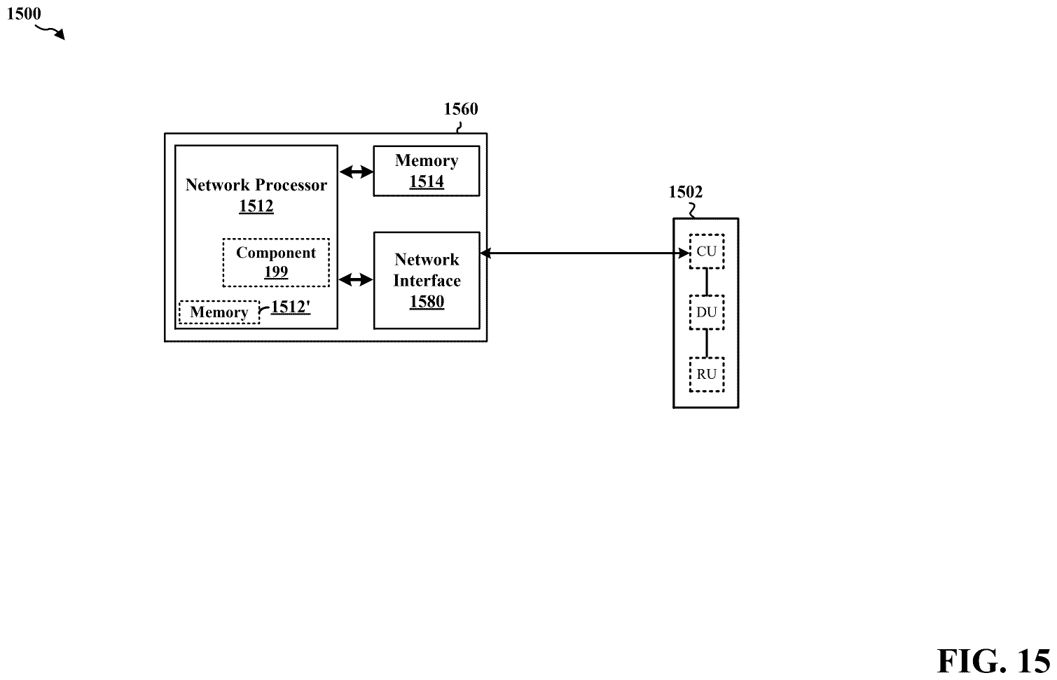

FIG. 9 is a flowchart 900 of a method of wireless communication. The method may be performed by a network node (e.g., the base station 102, base station 310; the network node 402, the network node 602, the network node 702, the network entity 1402, the network entity 1560). At 902, the network node may obtain a capability report associated with a RIS. The capability report may be associated with reflection and sensing capabilities of the RIS. For example, 902 may be performed by the network node 602 in FIG. 6, which may obtain a capability report 608 from the RIS 604 associated with the RIS 604. The capability report 608 may be associated with reflection and sensing capabilities of the RIS. Moreover, 902 may be performed by the component 199 in FIG. 14 or 15.

At 904, the network node may transmit a first configuration of resources associated with at least one RS. The network node may transmit a second configuration of at least one mode associated with the reflection and sensing capabilities of the RIS. The at least one mode may be associated with the at least one RS. The at least one mode may include a hybrid sensing and reflection mode. For example, 904 may be performed by the network node 602 in FIG. 6, which may transmit one or more RS resource configurations 612 associated with the one or more RSs 622 to the RIS 604 or the one or more RS resource configurations 614 associated with the one or more RSs 622 to the UE 606. The network node 602 may transmit one or more RIS mode configurations 618 of at least one mode associated with the reflection and sensing capabilities of the RIS 604 to the RIS 604. The at least one mode may be associated with the RIS 604. The at least one mode may include a hybrid sensing and reflection mode. Moreover, 904 may be performed by the component 199 in FIG. 14 or 15.

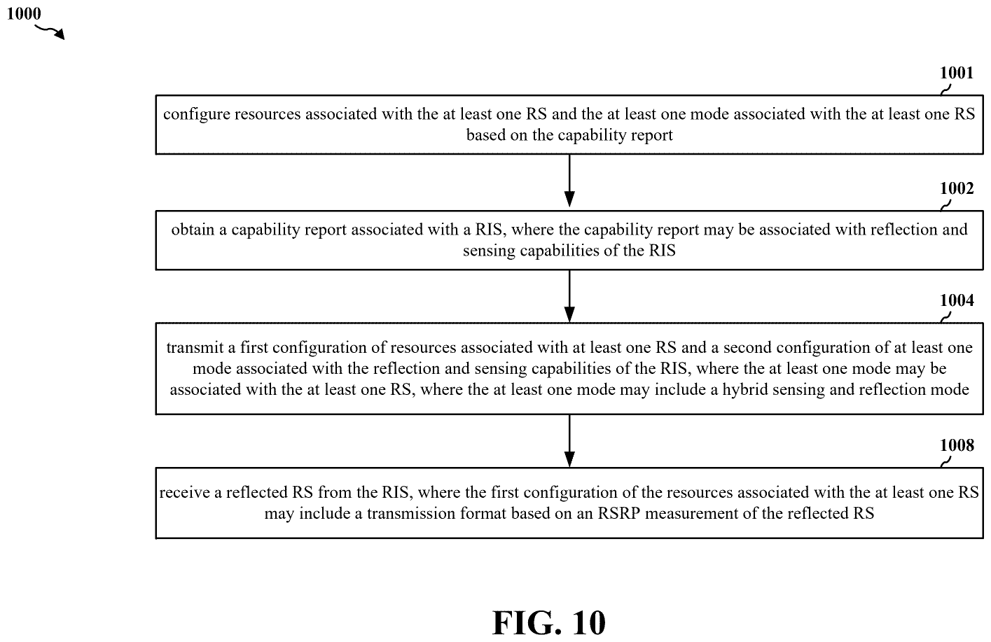

FIG. 10 is a flowchart 1000 of a method of wireless communication. The method may be performed by a network node (e.g., the base station 102, base station 310; the network node 402, the network node 602, the network node 702, the network entity 1402, the network entity 1560). At 1002, the network node may obtain a capability report associated with a RIS. The capability report may be associated with reflection and sensing capabilities of the RIS. For example, 1002 may be performed by the network node 602 in FIG. 6, which may obtain a capability report 608 from the RIS 604 associated with the RIS 604. The capability report 608 may be associated with reflection and sensing capabilities of the RIS. Moreover, 1002 may be performed by the component 199 in FIG. 14 or 15.

At 1004, the network node may transmit a first configuration of resources associated with at least one RS and a second configuration of at least one mode associated with the reflection and sensing capabilities of the RIS, where the at least one mode may be associated with the at least one RS. The at least one mode may include a hybrid sensing and reflection mode. For example, 1004 may be performed by the network node 602 in FIG. 6, which may transmit one or more RS resource configurations 612 associated with the one or more RSs 622 to the RIS 604 or the one or more RS resource configurations 614 associated with the one or more RSs 622 to the UE 606. The network node 602 may transmit one or more RIS mode configurations 618 of at least one mode associated with the reflection and sensing capabilities of the RIS 604 to the RIS 604. The at least one mode may be associated with the RIS 604. The at least one mode may include a hybrid sensing and reflection mode. Moreover, 1004 may be performed by the component 199 in FIG. 14 or 15.

At 1001, the network node may configure the resources associated with the at least one RS and the at least one mode associated with the at least one RS based on the capability report. For example, 1001 may be performed by the network node 602 in FIG. 6, which may configure the RS resources at 610 associated with the one or more RSs 622 and the at least one mode associated with the one or more RSs 622 based on the capability report 608. Moreover, 1001 may be performed by the component 199 in FIG. 14 or 15.

At 1008, the network node may receive a reflected RS from the RIS. The first configuration of the resources associated with the at least one RS may include a transmission format based on an RSRP measurement of the reflected RS. For example, 1008 may be performed by the network node 602 in FIG. 6, which may receive one or more reflected RSs 624 from the RIS 604. At 626, the network node 602 may process the one or more reflected RSs 624. The network node 602 may update the one or more RS resource configurations 612 associated with the one or more RSs 622 with an updated transmission format based on an RSRP measurement of the one or more reflected RSs 624. Moreover, 1008 may be performed by the component 199 in FIG. 14 or 15.

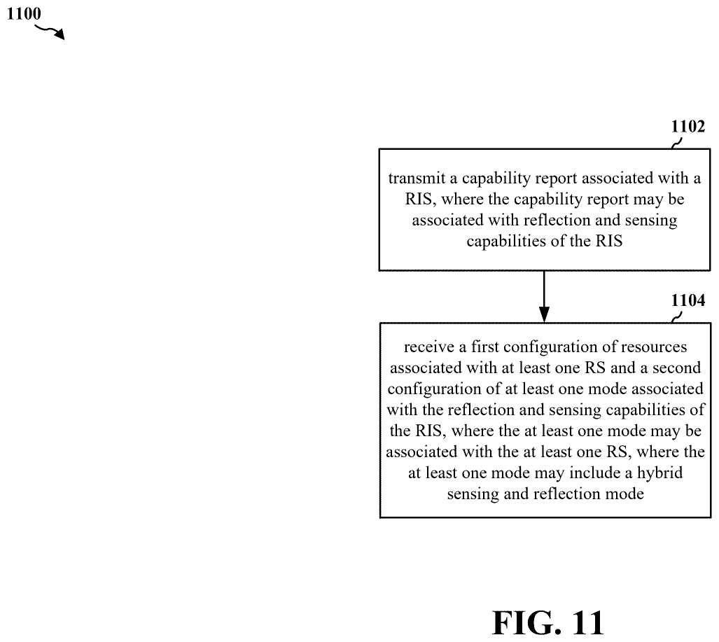

FIG. 11 is a flowchart 1100 of a method of wireless communication at a RIS. At 902, the RIS may transmit a capability report associated with a RIS. The capability report may be associated with reflection and sensing capabilities of the RIS. For example, 1102 may be performed by the RIS 604 in FIG. 6, which may transmit a capability report 608 associated with the RIS 604 to the network node 602. The capability report 608 may be associated with reflection and sensing capabilities of the RIS 604. Moreover, 1102 may be performed by the component 198 in FIG. 4 or 5.

At 1104, the RIS may receive a first configuration of resources associated with at least one RS. The RIS may receive a second configuration of at least one mode associated with the reflection and sensing capabilities of the RIS. The at least one mode may be associated with the at least one RS. The at least one mode may include a hybrid sensing and reflection mode. For example, 1104 may be performed by the RIS 604, which may receive one or more RS resource configurations 612 associated with the one or more RSs 622 from the network node 602. The RIS 604 may receive one or more RIS mode configurations 618 of at least one mode associated with the reflection and sensing capabilities of the RIS 604. The at least one mode may be associated with the one or more RSs 622. Moreover, 1104 may be performed by the component 198 in FIG. 4 or 5.

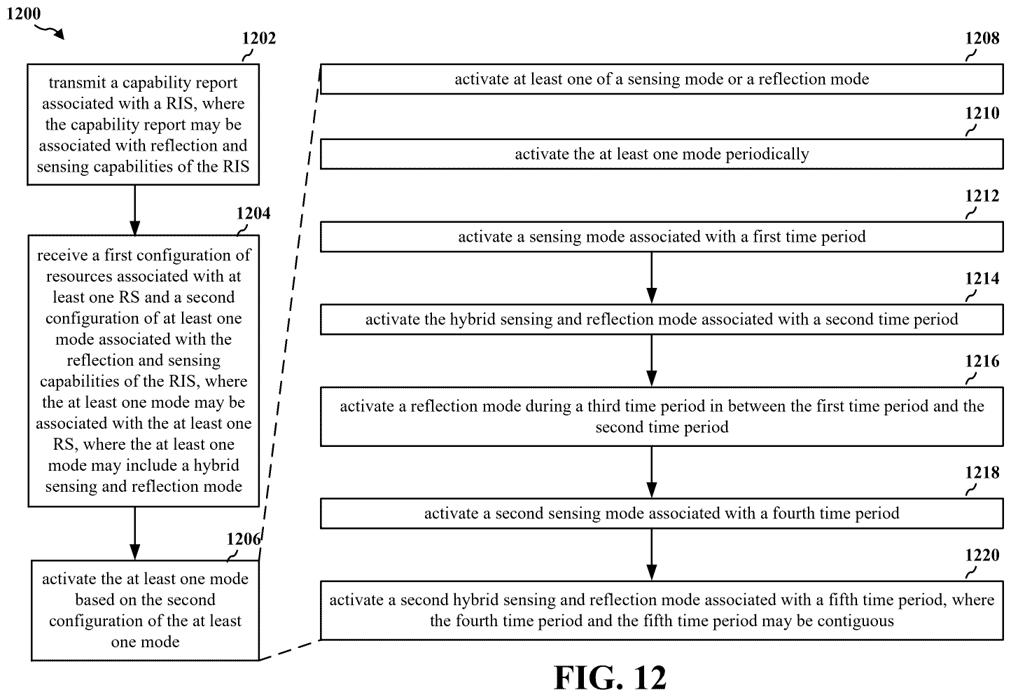

FIG. 12 is a flowchart 1200 of a method of wireless communication at a RIS. At 1202, the RIS may transmit a capability report associated with a RIS. The capability report may be associated with reflection and sensing capabilities of the RIS. For example, 1202 may be performed by the RIS 604 in FIG. 6, which may transmit a capability report 608 associated with the RIS 604 to the network node 602. The capability report 608 may be associated with reflection and sensing capabilities of the RIS 604. Moreover, 1202 may be performed by the component 198 in FIG. 4 or 5.

At 1204, the RIS may receive a first configuration of resources associated with at least one RS and a second configuration of at least one mode associated with the reflection and sensing capabilities of the RIS. The at least one mode may be associated with the at least one RS. The at least one mode may include a hybrid sensing and reflection mode. For example, 1204 may be performed by the RIS 604, which may receive one or more RS resource configurations 612 associated with the one or more RSs 622 from the network node 602. The RIS 604 may receive one or more RIS mode configurations 618 of at least one mode associated with the reflection and sensing capabilities of the RIS 604. The at least one mode may be associated with the one or more RSs 622. Moreover, 1204 may be performed by the component 198 in FIGS. 4 or 5.

At 1206, the RIS activate the at least one mode based on the second configuration of the at least one mode. For example, 1206 may be performed by the RIS 604 in FIG. 6, which may activate the at least one mode at 620 based on the one or more RIS mode configurations 618. Moreover, 1206 may be performed by the component 198 in FIGS. 4 or 5.

At 1208, the RIS may activate at least one of a sensing mode or a reflection mode. For example, 1208 may be performed by the RIS 604 in FIG. 6, which may activate at least one of the sensing mode or the reflection mode at 620. 1208 may also be performed by the RIS 704 in FIG. 7, which may activate the sensing mode at 708 or the reflection mode at 714. Moreover, 1208 may be performed by the component 198 in FIG. 4 or 5.

At 1210, the RIS may activate the at least one mode periodically. For example, 1210 may be performed by the RIS 604 in FIG. 6, which may activate the at least one mode at 620 periodically. Moreover, 1210 may be performed by the component 198 in FIGS. 4 or 5.

At 1212, the RIS may activate a sensing mode associated with a first time period. For example, 1212 may be performed by the RIS 604 in FIG. 6, which may activate a sensing mode at 620 associated with a first time period. For example, the sensing mode 802 in FIG. 8A for a period of time. Moreover, 1212 may be performed by the component 198 in FIGS. 4 or 5.

At 1214, the RIS may activate the hybrid sensing and reflection mode associated with a second time period. For example, 1214 may be performed by the RIS 604 in FIG. 6, which may activate the hybrid sensing and reflection mode associated with a second time period. For example, the hybrid sensing and reflection mode 804 in FIG. 8A. Moreover, 1214 may be performed by the component 198 in FIG. 4 or 5.

At 1216, the RIS may activate a reflection mode during a third time period in between the first time period and the second time period. For example, 1216 may be performed by the RIS 604 in FIG. 6, which may activate a reflection mode during a third time period in between the first time period and the second time period. For example, the reflection mode 803 in FIG. 8B in between the sensing mode 802 and the hybrid sensing and reflection mode 804. Moreover, 1216 may be performed by the component 198 in FIGS. 4 or 5.

At 1218, the RIS may activate a second sensing mode associated with a fourth time period. For example, 1218 may be performed by the RIS 604 in FIG. 6, which may activate a second sensing mode associated with a fourth time period. For example, the sensing mode 806 in FIG. 8A. Moreover, 1218 may be performed by the component 198 in FIGS. 4 or 5.

At 1220, the RIS may activate a second hybrid sensing and reflection mode associated with a fifth time period. The fourth time period and the fifth time period may be contiguous. For example, 1220 may be performed by the RIS 604 in FIG. 6, which may activate a second hybrid sensing and reflection mode associated with a fifth time period. For example, the hybrid sensing and reflection mode 808 in FIG. 8A. The time period for the sensing mode 806 may be contiguous with the time period for the hybrid sensing and reflection mode 808. Moreover, 1220 may be performed by the component 198 in FIGS. 4 or 5.

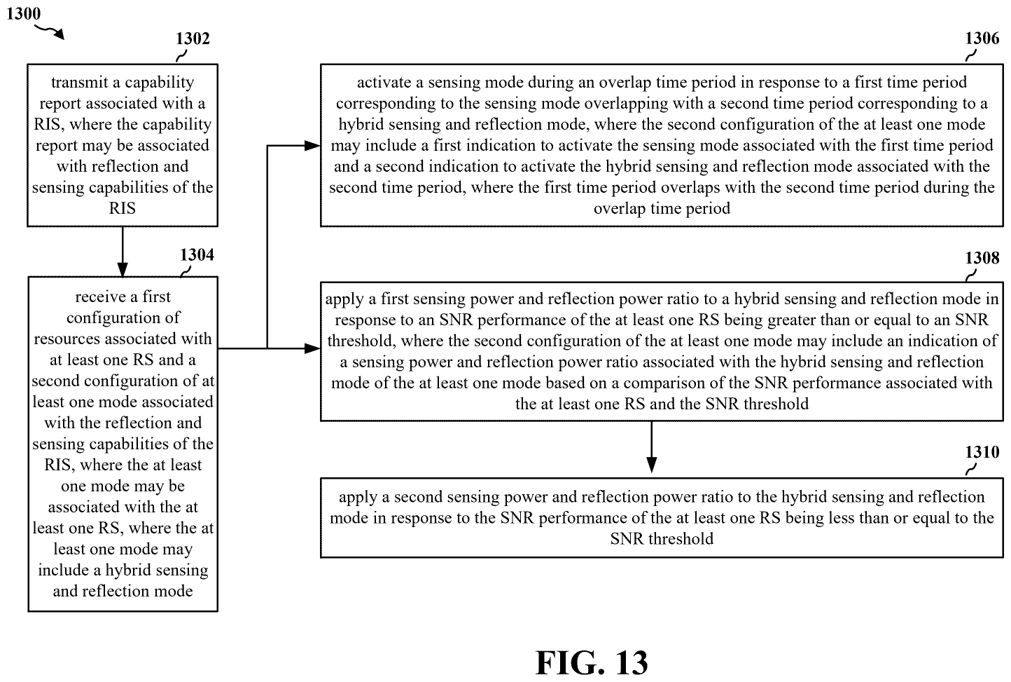

FIG. 13 is a flowchart 1300 of a method of wireless communication at a RIS. At 1302, the RIS may transmit a capability report associated with a RIS. The capability report may be associated with reflection and sensing capabilities of the RIS. For example, 1302 may be performed by the RIS 604 in FIG. 6, which may transmit a capability report 608 associated with the RIS 604 to the network node 602. The capability report 608 may be associated with reflection and sensing capabilities of the RIS 604. Moreover, 1302 may be performed by the component 198 in FIGS. 4 or 5.

At 1304, the RIS may receive a first configuration of resources associated with at least one RS and a second configuration of at least one mode associated with the reflection and sensing capabilities of the RIS. The at least one mode may be associated with the at least one RS. The at least one mode may include a hybrid sensing and reflection mode. For example, 1304 may be performed by the RIS 604, which may receive one or more RS resource configurations 612 associated with the one or more RSs 622 from the network node 602. The RIS 604 may receive one or more RIS mode configurations 618 of at least one mode associated with the reflection and sensing capabilities of the RIS 604. The at least one mode may be associated with the one or more RSs 622. Moreover, 1304 may be performed by the component 198 in FIGS. 4 or 5.

At 1306, the RIS may activate a sensing mode during an overlap time period in response to a first time period corresponding to the sensing mode overlapping with a second time period corresponding to a hybrid sensing and reflection mode. The second configuration of the at least one mode may include a first indication to activate the sensing mode associated with the first time period and a second indication to activate the hybrid sensing and reflection mode associated with the second time period. The first time period overlaps with the second time period during the overlap time period. For example, 1306 may be performed by the RIS 604 in FIG. 6, which may activate a sensing mode during an overlap time period in response to a first time period corresponding to the sensing mode overlapping with a second time period corresponding to a hybrid sensing and reflection mode. The second configuration of the at least one mode may include a first indication to activate the sensing mode associated with the first time period and a second indication to activate the hybrid sensing and reflection mode associated with the second time period. The first time period overlaps with the second time period during the overlap time period. Moreover, 1306 may be performed by the component 198 in FIG. 4 or 5.

At 1308, the RIS may apply a first sensing power and reflection power ratio to a hybrid sensing and reflection mode in response to an SNR performance of the at least one RS being greater than or equal to an SNR threshold. The second configuration of the at least one mode may include an indication of a sensing power and reflection power ratio associated with the hybrid sensing and reflection mode of the at least one mode based on a comparison of the SNR performance associated with the at least one RS and the SNR threshold. For example, 1308 may be performed by the RIS 604 in FIG. 6, which may apply a first sensing power and reflection power ratio to a hybrid sensing and reflection mode in response to an SNR performance of the at least one RS being greater than or equal to an SNR threshold. The second configuration of the at least one mode may include an indication of a sensing power and reflection power ratio associated with the hybrid sensing and reflection mode of the at least one mode based on a comparison of the SNR performance associated with the at least one RS and the SNR threshold. Moreover, 1308 may be performed by the component 198 in FIGS. 4 or 5.

At 1310, the RIS may apply a second sensing power and reflection power ratio to the hybrid sensing and reflection mode in response to the SNR performance of the at least one RS being less than or equal to the SNR threshold. For example, 1310 may be performed by the RIS 604 in FIG. 6, which may apply a second sensing power and reflection power ratio to the hybrid sensing and reflection mode in response to the SNR performance of the at least one RS being less than or equal to the SNR threshold. Moreover, 13010 may be performed by the component 198 in FIGS. 4 or 5.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to obtain a capability report associated with a RIS. The capability report may be associated with reflection and sensing capabilities of the RIS. The component 199 may be configured to transmit a first configuration of resources associated with at least one RS and a second configuration of at least one mode associated with the reflection and sensing capabilities of the RIS. The at least one mode may be associated with the at least one RS. The at least one mode may include a hybrid sensing and reflection mode. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for obtaining a capability report associated with a RIS. The network entity 1402 may include means for transmitting a first configuration of resources associated with at least one RS and a second configuration of at least one mode associated with the reflection and sensing capabilities of the RIS. The network entity 1402 may include means for configuring the resources associated with the at least one RS and the at least one mode associated with the at least one RS based on the capability report. The network entity 1402 may include means for receiving a reflected RS from the RIS. The means may be the component 199 of the network entity 1402 configured to perform the functions recited by the means. As described supra, the network entity 1402 may include the Tx processor 316, the Rx processor 370, and the controller/processor 375. As such, in one configuration, the means may be the Tx processor 316, the Rx processor 370, and/or the controller/processor 375 configured to perform the functions recited by the means.

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to obtain a capability report associated with a RIS. The capability report may be associated with reflection and sensing capabilities of the RIS. The component 199 may be configured to transmit a first configuration of resources associated with at least one RS and a second configuration of at least one mode associated with the reflection and sensing capabilities of the RIS. The at least one mode may be associated with the at least one RS. The at least one mode may include a hybrid sensing and reflection mode. The component 199 may be within the processor 1512. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1560 may include a variety of components configured for various functions. In one configuration, the network entity 1560 includes means for obtaining a capability report associated with a RIS. The network entity 1560 may include means for transmitting a first configuration of resources associated with at least one RS and a second configuration of at least one mode associated with the reflection and sensing capabilities of the RIS. The network entity 1560 may include means for configuring the resources associated with the at least one RS and the at least one mode associated with the at least one RS based on the capability report. The network entity 1560 may include means for receiving a reflected RS from the RIS. The means may be the component 199 of the network entity 1560 configured to perform the functions recited by the means.

A system having a RIS, such as the RIS 604 in FIG. 6, configured to be switched between a sensing mode, a reflection mode, and a hybrid sensing and reflection mode enables a network node to adjust a mode of a RIS to dynamically adjust its performance for optimization purposes. In one aspect, a RIS that switches between a sensing mode and a reflection mode to derive reflection coefficients and reflect an incident signal, respectively, may have a high signal-to-noise ratio (SNR) for either sensing at the RIS or for data reception at a UE or a network node that receives the reflected signal. However, frequent sensing may lead to low spectrum efficiency if the channel status changes slowly (e.g., the channel status changes once for every 5 periodic sensing modes). Moreover, infrequent sensing may lead to a delayed reflection coefficient update when the channel status changes quickly. In one aspect, a RIS that uses a hybrid sensing and reflection mode may have a good balance between real-time sensing and high data transmission throughput. However, a RIS that uses a hybrid sensing and reflection mode may have low SNR for sensing at the RIS, or low SNR for data reception at a UE or a network node that receives the reflected signal. By allowing a network node to dynamically change the mode of the RIS between a sensing mode, a reflection mode, and a hybrid sensing and a reflection mode, the network node may optimize the ability for the RIS to maximize the SNR while also maintaining a good balance between real-time sensing and high data transmission throughput.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include obtaining a capability report associated with a RIS. The capability report may be associated with reflection and sensing capabilities of the RIS. The method may include transmitting a first configuration of resources associated with at least one RS and a second configuration of at least one mode associated with the reflection and sensing capabilities of the RIS. The at least one mode may be associated with the at least one RS. The at least one mode may include a hybrid sensing and reflection mode.

Aspect 2 is the method of aspect 1, where the method may include configuring the resources associated with the at least one RS and the at least one mode associated with the at least one RS based on the capability report.

Aspect 3 is the method of any of aspects 1 to 2, where the at least one mode may further include at least one of a sensing mode or a reflection mode.

Aspect 4 is the method of any of aspects 1 to 3, where the second configuration of the at least one mode may include a first indication to activate a sensing mode associated with a first time period and a second indication to activate the hybrid sensing and reflection mode associated with a second time period.

Aspect 5 is the method of aspect 4, where at least one of the first time period or the second time period may have a same start time as a start time of an UL transmission of the at least one RS associated with the first configuration of the resources.

Aspect 6 is the method of any of aspects 1 to 5, where the first configuration of the resources does not include a DL transmission resource that overlaps with a time period of a sensing mode or the hybrid sensing and reflection mode of the second configuration of the at least one mode.

Aspect 7 is the method of any of aspects 1 to 6, where the second configuration of the at least one mode may include an indication to activate of the at least one mode periodically.

Aspect 8 is the method of any of aspects 1 to 7, where the second configuration of the at least one mode may include an indication of a sensing power and reflection power ratio associated with the hybrid sensing and reflection mode of the at least one mode based on a comparison of an SNR performance associated with the at least one RS and an SNR threshold.

Aspect 9 is the method of any of aspects 1 to 8, where the method may include receiving a reflected RS from the RIS. The first configuration of the resources associated with the at least one RS may include a transmission format based on an RSRP measurement of the reflected RS.

Aspect 10 is the method of any of aspects 1 to 9, where the first configuration of the resources associated with the at least one RS may include at least one parameter associated with the at least one RS. The at least one parameter may include one or more of at least one set of resources associated with the at least one RS, at least one grant associated with the at least one RS, or at least one RS identifier associated with the at least one RS.

Aspect 11 is the method of any of aspects 1 to 10, where the capability report may include a first time-domain length associated with the RIS to complete sensing. The first configuration of the resources may include a second time-domain length associated with the at least one RS based on the first time-domain length.

Aspect 12 is a method of wireless communication at a RIS, where the method may include transmitting a capability report associated with the RIS. The capability report may be associated with reflection and sensing capabilities of the RIS. The method may include receiving a first configuration of resources associated with at least one RS and a second configuration of at least one mode associated with the reflection and sensing capabilities of the RIS. The at least one mode may be associated with the at least one RS. The at least one mode may include a hybrid sensing and reflection mode

Aspect 13 is the method of aspect 12, where the method may include activating the at least one mode based on the second configuration of the at least one mode.

Aspect 14 is the method of aspect 13, where activating the at least one mode based on the second configuration of the at least one mode may include activating at least one of a sensing mode or a reflection mode.

Aspect 15 is the method of any of aspects 13 to 14, where activating the at least one mode based on the second configuration of the at least one mode may include activating a sensing mode associated with a first time period. Activating the at least one mode based on the second configuration of the at least one mode may include activating the hybrid sensing and reflection mode associated with a second time period.

Aspect 16 is the method of aspect 15, where at least one of the first time period or the second time period has a same start time as a start time of an UL transmission of the first configuration of the resources.

Aspect 17 is the method of any of aspects 15 to 16, where activating the at least one mode based on the second configuration of the at least one mode may include activating a reflection mode during a third time period in between the first time period and the second time period.

Aspect 18 is the method of aspect 17, where activating the at least one mode based on the second configuration of the at least one mode may include activating a second sensing mode associated with a fourth time period. Activating the at least one mode based on the second configuration of the at least one mode may include activating a second hybrid sensing and reflection mode associated with a fifth time period. The fourth time period and the fifth time period may be contiguous.

Aspect 19 is the method of any of aspects 13 to 18, where the second configuration of the at least one mode may include a first indication to activate a sensing mode associated with a first time period and a second indication to activate the hybrid sensing and reflection mode associated with a second time period. The first time period may overlap with the second time period during an overlap time period. Activating the at least one mode based on the second configuration of the at least one mode may include activating the sensing mode during the overlap time period in response to the first time period overlapping with the second time period during the overlap time period.

Aspect 20 is the method of any of aspects 13 to 19, where the first configuration of the resources may not include a DL transmission resource that overlaps with a time period of a sensing mode or the hybrid sensing and reflection mode of the second configuration of the at least one mode.

Aspect 21 is the method of any of aspects 13 to 20, where activating the at least one mode based on the second configuration of the at least one mode may include activating the at least one mode periodically.

Aspect 22 is the method of any of aspects 12 to 21, where the second configuration of the at least one mode may include an indication of a sensing power and reflection power ratio associated with the hybrid sensing and reflection mode of the at least one mode based on a comparison of an SNR performance associated with the at least one RS and an SNR threshold.

Aspect 23 is the method of aspect 22, where the method may include applying a first sensing power and reflection power ratio to the hybrid sensing and reflection mode in response to the SNR performance of the at least one RS being greater than or equal to the SNR threshold. The method may include applying a second sensing power and reflection power ratio to the hybrid sensing and reflection mode in response to the SNR performance of the at least one RS being less than or equal to the SNR threshold.

Aspect 24 is the method of any of aspects 13 to 23, where the first configuration of the resources may include at least one parameter associated with the at least one RS. The at least one parameter may include one or more of at least one set of resources associated with the at least one RS, at least one grant associated with the at least one RS, at least one RS identifier associated with the at least one RS, or at least one transmission format associated with the at least one RS.

Aspect 25 is the method of any of aspects 13 to 24, where the capability report may include at least one of a first indication to support a sensing mode, a second indication to support the hybrid sensing and reflection mode, or a first time-domain length for the RIS to complete sensing.

Aspect 26 is the method of any of aspects 13 to 25, where the method may include estimating an AoA of the at least one RS based on the first configuration of the resources during at least one of a sensing mode or the hybrid sensing and reflection mode of the at least one mode. The method may include adjusting a meta-element reflection coefficient based on the estimate of the AoA. The method may include reflecting the at least one RS during at least one of the hybrid sensing and reflection mode or a reflection mode of the at least one mode.

Aspect 27 is the method of aspect 26, where adjusting the meta-element reflection coefficient may include adjusting the meta-element reflection coefficient during the hybrid sensing and reflection mode based on the estimate of the AoA received during the hybrid sensing and reflection mode.

Aspect 28 is the method of any of aspects 26 to 27, where the first configuration of the resources may include at least one RS identifier associated with the at least one RS. Reflecting the at least one RS may include reflecting the at least one RS based on the at least one RS identifier associated with the at least one RS.

Aspect 29 is an apparatus for wireless communication, including: a memory; and at least one processor coupled to the memory and, based at least in part on information stored in the memory, the at least one processor is configured to implement any of aspects 1 to 28.

Aspect 29 is the apparatus of aspect 28, further including at least one of an antenna or a transceiver coupled to the at least one processor.

Aspect 30 is an apparatus for wireless communication including means for implementing any of aspects 1 to 28.

Aspect 31 is a computer-readable medium (e.g., a non-transitory computer-readable medium) storing computer executable code, where the code when executed by a processor causes the processor to implement any of aspects 1 to 28.

What is claimed is:

1. An apparatus for wireless communication at a network node, comprising:
a memory; and
at least one processor coupled to the memory and, based at least in part on information stored in the memory, the at least one processor is configured to:
obtain a capability report associated with a reconfigurable intelligent surface (RIS), wherein the capability report is associated with reflection and sensing capabilities of the RIS; and
transmit a first configuration of resources associated with at least one reference signal (RS) and a second configuration of at least one mode associated with the reflection and sensing capabilities of the RIS, wherein the at least one mode is associated with the at least one RS, wherein the at least one mode includes a hybrid sensing and reflection mode.

2. The apparatus of claim 1, wherein the at least one processor is further configured to:
configure the resources associated with the at least one RS and the at least one mode associated with the at least one RS based on the capability report.

3. The apparatus of claim 1, wherein the at least one mode further includes at least one of a first sensing mode or a first reflection mode.

4. The apparatus of claim 1, wherein the second configuration of the at least one mode comprises a first indication to activate a sensing mode associated with a first time period and a second indication to activate the hybrid sensing and reflection mode associated with a second time period.

5. The apparatus of claim 4, wherein at least one of the first time period or the second time period has a same start time as a start time of an uplink (UL) transmission of the at least one RS associated with the first configuration of the resources.

6. The apparatus of claim 1, wherein the first configuration of the resources does not include a downlink (DL) transmission resource that overlaps with a time period of a sensing mode or the hybrid sensing and reflection mode of the second configuration of the at least one mode.

7. The apparatus of claim 1, wherein the second configuration of the at least one mode comprises an indication to activate of the at least one mode periodically.

8. The apparatus of claim 1, wherein the second configuration of the at least one mode comprises an indication of a sensing power and reflection power ratio associated with the hybrid sensing and reflection mode of the at least one mode based on a comparison of a signal-to-noise ratio (SNR) performance associated with the at least one RS and an SNR threshold.

9. The apparatus of claim 1, wherein the at least one processor is further configured to:
receive a reflected RS from the RIS, wherein the first configuration of the resources associated with the at least one RS comprises a transmission format based on a reference signal received power (RSRP) measurement of the reflected RS.

10. The apparatus of claim 1, further comprising a transceiver coupled to the at least one processor, wherein to transmit the first configuration of resources comprises transmitting the first configuration of resources using the transceiver, wherein the first configuration of the resources associated with the at least one RS includes at least one parameter associated with the at least one RS, wherein the at least one parameter comprises one or more of at least one set of resources associated with the at least one RS, at least one grant associated with the at least one RS, or at least one RS identifier associated with the at least one RS.

11. The apparatus of claim 1, wherein the capability report comprises a first time-domain length associated with the RIS to complete sensing, wherein the first configuration of the resources comprises a second time-domain length associated with the at least one RS based on the first time-domain length.

12. An apparatus for wireless communication at a reconfigurable intelligent surface (RIS), comprising:
a memory; and
at least one processor coupled to the memory and, based at least in part on information stored in the memory, the at least one processor is configured to:
transmit a capability report associated with the RIS, wherein the capability report is associated with reflection and sensing capabilities of the RIS; and
receive a first configuration of resources associated with at least one reference signal (RS) and a second configuration of at least one mode associated with the reflection and sensing capabilities of the RIS, wherein the at least one mode is associated with the at least one RS, wherein the at least one mode includes a hybrid sensing and reflection mode.

13. The apparatus of claim 12, wherein the at least one processor is further configured to:
activate the at least one mode based on the second configuration of the at least one mode.

14. The apparatus of claim 13, wherein to activate the at least one mode based on the second configuration of the at least one mode the at least one processor is further configured to:
activate at least one of a first sensing mode or a first reflection mode.

15. The apparatus of claim 13, wherein to activate the at least one mode based on the second configuration of the at least one mode the at least one processor is further configured to:
activate a sensing mode associated with a first time period; and
activate the hybrid sensing and reflection mode associated with a second time period.

16. The apparatus of claim 15, wherein at least one of the first time period or the second time period has a same start time as a start time of an uplink (UL) transmission of the first configuration of the resources.

17. The apparatus of claim 15, wherein to activate the at least one mode based on the second configuration of the at least one mode the at least one processor is further configured to:
activate a first reflection mode during a third time period in between the first time period and the second time period.

18. The apparatus of claim 17, wherein to activate the at least one mode based on the second configuration of the at least one mode the at least one processor is further configured to:
activate a second sensing mode associated with a fourth time period; and
activate a second hybrid sensing and reflection mode associated with a fifth time period, wherein the fourth time period and the fifth time period are contiguous.

19. The apparatus of claim 13, wherein the second configuration of the at least one mode comprises a first indication to activate a sensing mode associated with a first time period and a second indication to activate the hybrid sensing and reflection mode associated with a second time period, wherein the first time period overlaps with the second time period during an overlap time period, wherein to activate the at least one mode based on the second configuration of the at least one mode the at least one processor is further configured to:
activate the sensing mode during the overlap time period in response to the first time period overlapping with the second time period during the overlap time period.

20. The apparatus of claim 13, wherein the first configuration of the resources does not include a downlink (DL) transmission resource that overlaps with a time period of a sensing mode or the hybrid sensing and reflection mode of the second configuration of the at least one mode.

21. The apparatus of claim 13, wherein to activate the at least one mode based on the second configuration of the at least one mode the at least one processor is further configured to:
activate the at least one mode periodically.

22. The apparatus of claim 12, wherein the second configuration of the at least one mode comprises an indication of a sensing power and reflection power ratio associated with the hybrid sensing and reflection mode of the at least one mode based on a comparison of a signal-to-noise ratio (SNR) performance associated with the at least one RS and an SNR threshold.

23. The apparatus of claim 22, wherein the at least one processor is further configured to:
apply a first sensing power and reflection power ratio to the hybrid sensing and reflection mode in response to the SNR performance associated with the at least one RS being greater than or equal to the SNR threshold; and
apply a second sensing power and reflection power ratio to the hybrid sensing and reflection mode in response to the SNR performance associated with the at least one RS being less than or equal to the SNR threshold.

24. The apparatus of claim 12, further comprising a transceiver coupled to the at least one processor, wherein to receive the first configuration of resources the at least one processor is further configured to receive the first configuration of resources using the transceiver, wherein the first configuration of the resources includes at least one parameter associated with the at least one RS, wherein the at least one parameter comprises one or more of at least one set of resources associated with the at least one RS, at least one grant associated with the at least one RS, at least one RS identifier associated with the at least one RS, or at least one transmission format associated with the at least one RS.

25. The apparatus of claim 12, wherein the capability report comprises at least one of a first indication to support a sensing mode, a second indication to support the hybrid sensing and reflection mode, or a first time-domain length for the RIS to complete sensing.

26. The apparatus of claim 12, wherein the at least one processor is further configured to:
estimate an angle of arrival (AoA) of the at least one RS based on the first configuration of the resources during at least one of a sensing mode or the hybrid sensing and reflection mode of the at least one mode;
adjust a meta-element reflection coefficient based on the estimate of the AoA; and
reflect the at least one RS during at least one of the hybrid sensing and reflection mode or a first reflection mode of the at least one mode.

27. The apparatus of claim 26, wherein to adjust the meta-element reflection coefficient the at least one processor is further configured to:
adjust the meta-element reflection coefficient during the hybrid sensing and reflection mode based on the estimate of the AoA received during the hybrid sensing and reflection mode.

28. The apparatus of claim 26, wherein the first configuration of the resources comprises at least one RS identifier associated with the at least one RS, wherein to reflect the at least one RS the at least one processor is further configured to:
reflect the at least one RS based on the at least one RS identifier associated with the at least one RS.

29. A method of wireless communication at a network node, comprising:
obtaining a capability report associated with a reconfigurable intelligent surface (RIS), wherein the capability report is associated with reflection and sensing capabilities of the RIS; and
transmitting a first configuration of resources associated with at least one reference signal (RS) and a second configuration of at least one mode associated with the reflection and sensing capabilities of the RIS, wherein the at least one mode is associated with the at least one RS, wherein the at least one mode includes a hybrid sensing and reflection mode.

30. A method of wireless communication at a reconfigurable intelligent surface (RIS), comprising:
transmitting a capability report associated with the RIS, wherein the capability report is associated with reflection and sensing capabilities of the RIS; and
receiving a first configuration of resources associated with at least one reference signal (RS) and a second configuration of at least one mode associated with the reflection and sensing capabilities of the RIS, wherein the at least one mode is associated with the at least one RS, wherein the at least one mode includes a hybrid sensing and reflection mode.
